(19) United States
(12) Patent Application Publication
(10) Pub. No.: US 2025/0390702 A1
(43) Pub. Date: Dec. 25, 2025

(54) 3D POINT CLOUD QUALITY PREDICTION METHOD BASED ON GRAPH CONVOLUTIONAL NEURAL NETWORK

(71) Applicant: Ningbo University, Ningbo (CN)

(72) Inventors: Qiuping Jiang, Ningbo (CN); Wu Chen, Ningbo (CN); Feng Shao, Ningbo (CN); Chunmao Wang, Ningbo (CN); Yong Liu, Ningbo (CN)

(73) Assignee: Ningbo University, Ningbo (CN)

(21) Appl. No.: 19/312,271

(22) Filed: Aug. 27, 2025

(30) Foreign Application Priority Data
Sep. 18, 2024 (CN) 202411300138.3

(51) Int. Cl. G06N 3/042; G06N 3/0464; G06N 3/08; H04N 19/597

(52) U.S. Cl. CPC G06N 3/042; G06N 3/0464; G06N 3/08; H04N 19/597

(57) ABSTRACT

A 3D point cloud quality prediction method based on graph convolutional neural network is provided. The beneficial effect is that the present disclosure can effectively capture global structural information, reduce redundant calculations, and improve the accuracy of the predict quality score.

### TECHNICAL FIELD

The present disclosure relates to the technical field of point cloud quality assessment, specifically relates to a three-dimensional (3D) point cloud quality prediction method based on a graph convolutional neural network.

### BACKGROUND

In recent years, the development of 3D visual information acquisition technology has made point clouds easier to acquire, and they have gradually become a popular type of visual data. This 3D visual data is typically represented in the form of point clouds, voxels or meshes. Because point clouds can completely and accurately describe 3D objects, they are considered as an effective method of 3D data representation. Point clouds are primarily used to describe a complete 3D scene or object, encompassing geometric properties, color properties, and other attributes (such as normal vectors, opacity, reflectivity, and time). At present, point clouds have been widely studied and applied in 3D reconstruction, classification and segmentation, facial expression representation, autonomous driving, virtual reality and other application scenarios. Although point clouds can realistically record 3D objects through huge point sets, they also consume a lot of memory, and it is difficult to achieve data transmission under limited network bandwidth. This novel and efficient way of data representation poses a challenge to the current hardware storage and network transmission. Consequently, in order to achieve efficient storage and transmission, the point cloud needs to be compressed.

Nevertheless, point cloud compression may introduce artifacts, leading to the degradation of point cloud visual quality. Effective point cloud quality prediction methods can not only help people predict the distortion degree of the point cloud and the performance of the compression algorithm, but also help to optimize the visual quality of the distorted point cloud. Therefore, how to accurately assess the perception quality of point cloud data has become a key issue. Among the existing point cloud quality assessment methods, point-based methods and projection-based methods have achieved certain results. However, most projection-based methods mainly rely on six projection planes for quality assessment, and do not consider the multi-view perception of point cloud quality by the human visual system. This means that the model fails to make full use of the correlation between different projection images for modeling, resulting in its insufficient ability to perceive the overall quality of the point cloud, making it unable to effectively capture global structural information, with redundant calculations and limited prediction accuracy.

### SUMMARY

The technical problem to be solved by the present disclosure is to achieve the effective capture of global structure information, reduce redundant calculations and improve the accuracy of predict quality score. In order to overcome the defects of the above prior art (or related art), the present disclosure provides a 3D point cloud quality prediction method based on a graph convolutional neural network.
the present disclosure provides a 3D point cloud quality prediction method based on a graph convolutional neural network, including the following steps:
step S1, for at least one 3D object, acquiring a dataset of the 3D object, wherein the dataset includes a plurality of distorted point clouds and a subjective quality score corresponding to each of the distorted point clouds, and then performing a dual-path multi-view projection on each of the distorted point clouds, and preprocessing the projection image to obtain a corresponding preprocessed projection image; and dividing each of the preprocessed projection images and the subjective quality score corresponding to each of the preprocessed projection images into a training set and a test set;
step S2, building a no-reference point cloud quality assessment network by using a deep learning framework, wherein the no-reference point cloud quality assessment network includes a backbone block, a multi-layer attention perception module, a multi-layer conversion module and a quality prediction module, receiving projection image sets of two paths through the backbone module and outputting a feature map X₂ and a feature map X₅, performing a convolutional operation, a feature map multiplication operation and a global average pooling operation in sequence on the feature map X₂ and the feature map X₅ through the multi-layer attention perception module to obtain a feature map X_{A2} and a feature map X_{A5}, processing the feature map X_{A2} and the feature map X_{A5} through the multi-layer attention conversion module to obtain a graph structure G_{H}={X_{H25},M_{H}} and a graph structure G_{V}={X_{V25},M_{V}}, and processing the graph structure G_{H}={X_{H25},M_{H}} and the graph structure G_{V}={X_{V25},M_{V}} through the quality prediction module to obtain a predict quality score S;
step S3, training the no-reference point cloud quality assessment network using the training set to obtain the predict quality score S corresponding to each of the distorted point clouds in the training set;
step S4: obtaining a no-reference point cloud quality assessment network model by training the no-reference point cloud quality assessment network for multiple epochs according to step S3; and
step S5, testing each of the distorted point clouds in the test set by the no-reference point cloud quality assessment network model, and outputting the predict quality score S of each of the distorted point clouds as an assessment result of the no-reference point cloud quality.

Compared with the prior art, the 3D point cloud quality prediction method based on a graph convolutional neural network in the present disclosure has the following advantages:
in the present disclosure, in step S1, dual-path multi-view projection is performed on the distorted point cloud to obtain two sets of projection images on different projection paths, and on this basis, the preprocessed projection image with high perception consistency is constructed by preprocessing to represent the interdependence relation between the different preprocessed projection images, thereby effectively capturing global structure information; in step S2, the graph convolutional network is applied to the graph structure to describe the global dependency relation between different preprocessed projection images, and feature information of multi-view projection images is aggregated, so as to effectively reduce redundant calculations and improve the global understanding ability of the 3D point cloud quality prediction method; in step S3, the no-reference point cloud quality assessment network is trained by using the training set, and in step S4, the no-reference point cloud quality assessment network is trained for multiple epochs, so as to improve the robustness of the no-reference point cloud quality assessment network model and effectively improve the accuracy of the predict quality score.

In a possible embodiment, in step S1, the dual-path multi-view projection is performed on each of the distorted point clouds in the dataset, the number of projection images obtained on each of the projection path is N, and then each of the projection images is preprocessed by size adjustment, cropping and normalization to obtain the preprocessed projection image with an image size of H×W×C.

In a possible embodiment, in step S1, the process of preprocessing each of the projection images includes:
performing the size adjustment and cropping on each of the projection images, scaling the size of each of the projection images to H×W×C, and then performing the normalization processing on each of the scaled projection images, normalizing pixel values of all pixels in a R channel of the scaled projection image to a mean value of 0.485 and a variance of 0.229, normalizing pixel values of all pixels in a G channel to a mean value of 0.456 and a variance of 0.224, and normalizing pixel values of all pixels in a B channel to a mean value of 0.406 and a variance of 0.225.

In a possible embodiment, in step S2, the backbone module is a ResNet101 backbone network including a five-layer structure, and the five-layer structure is connected in sequence, an input end of a first layer is configured as an input end of the backbone module and simultaneously receives the projection image sets of two paths, each of projection image sets includes the N preprocessed projection images with the size of H×W×C, and output ends of a second layer and a fifth layers are configured as multi-layer output ends of the backbone module, wherein the output end of the first layer outputs a feature map X₁, an input end of the second layer receives the feature map X₁, the output end of the second layer outputs a feature map X₂, an input end of a third layer receives the feature map X₂, an output end of the third layer outputs a feature map X₃, an input end of a fourth layer receives the feature map X₃, an output end of the fourth layer outputs a feature map X₄, an input end of the fifth layer receives the feature map X₄, and the output end of the fifth layer outputs the feature map X₅; wherein a size of the feature map X₁ is

$$2 N \times \frac{H}{4} \times \frac{W}{4} \times 64 ,$$

a size of the feature map X₂ is a

$$2 N \times \frac{H}{4} \times \frac{W}{4} \times 256 ,$$

a size of the feature map X₃ is

$$2 N \times \frac{H}{8} \times \frac{W}{8} \times 512 ,$$

a size of the feature map X₄ is

$$2 N \times \frac{H}{16} \times \frac{W}{16} \times 1024 ,$$

and a size of the feature map X₅ is

$$2 N \times \frac{H}{32} \times \frac{W}{32} \times 2048.$$

In a possible embodiment, in step S2, the multi-layer attention perception module obtains the feature map X_{A2} and the feature map X_{A5} through two branches, wherein the execution step of a first branch includes:
taking the feature map X₂ as input, performing a channel size compression through a convolutional layer with a convolutional kernel size of 1, a stride of 1, a padding of 0, a number of input channels of 256, and a number of output channels of 1, and mapping a feature value range to [0, 1] by applying a Sigmoid activation function to obtain an attention feature map A₂₁, wherein a size of the attention feature map A₂₁ is

$$2 N \times \frac{H}{4} \times \frac{W}{4} \times 1 ;$$

and taking the feature map X₂ as input, performing a global average pooling of spatial dimensions through a global average pooling layer, and then sequentially passing a convolutional layer with a convolutional kernel size of 1, a stride of 1, a padding of 0, a number of input channels of 256, and a number of output channels of 16, and a convolutional layer with a convolutional kernel size of 1, a stride of 1, a padding of 0, a number of input channels of 16, and a number of output channels of 256, and mapping the feature value range to [0, 1] by applying the Sigmoid activation function to obtain an attention feature map A₂₂, wherein a size of the attention feature map A₂₂ is 2N×1×1×256; then multiplying the attention feature map A₂₁ with the attention feature map A₂₂ to obtain a mixed attention feature map A₂, wherein a size of the mixed attention feature map A₂ is

$$2 N \times \frac{H}{4} \times \frac{W}{4} \times 256 ;$$

and multiplying the mixed attention feature map A₂ with the feature map X₂ and adding to the feature map X₂ by a residual connection, and performing a global average pooling operation to obtain a feature map X_{A2}, wherein a size of the feature map X_{A2} is 2N×256;
the executing step of a second branch includes:
taking the feature map X₅ as input, performing a channel size compression through a convolutional layer with a convolutional kernel size of 1, a stride of 1, a padding of 0, a number of input channels of 2048, and a number of output channels of 1, and mapping a feature value range to [0, 1] by applying a Sigmoid activation function to obtain an attention feature map A₅₁, wherein a size of the attention feature map A₅₁ is

$$2 N \times \frac{H}{32} \times \frac{W}{32} \times 1 ;$$

and taking the feature map X₅ as input, performing a global average pooling of spatial dimensions through a global average pooling layer, and then sequentially passing a convolutional layer with a convolutional kernel size of 1, a stride of 1, a padding of 0, a number of input channels of 2048, and a number of output channels of 128, and a convolutional layer with a convolutional kernel size of 1, a stride of 1, a padding of 0, a number of input channels of 128, and a number of output channels of 2048, and mapping the feature value range to [0, 1] by applying the Sigmoid activation function to obtain an attention feature map A₅₂, wherein a size of the attention feature map A₅₂ is 2N×1×1×2048; then multiplying the attention feature map A₅₁ with the attention feature map A₅₂ to obtain a mixed attention feature map A₅, wherein a size of the mixed attention feature map A₅ is

$$2 N \times \frac{H}{32} \times \frac{W}{32} \times 2048 ;$$

and multiplying the mixed attention feature map A₅ with the feature map X₅ and adding to the feature map X₅ by the residual connection, and performing a global average pooling operation to obtain a feature map X_{A5}, wherein a size of the feature map X_{A5} is 2N×2048;

In a possible embodiment, in step S2, the multi-layer conversion module includes a multi-layer feature fusion block and a map building block, a channel stitching is performed on the feature map X_{A2} and the feature map X_{A5} through the multi-layer feature fusion block to obtain a feature map X₂₅, a size of the feature map X₂₅ is 2N×2304, then the feature map is segmented according to the projection path of dual-path multi-view projection to obtain a horizontal projection feature map X_{H25} and a vertical projection feature map X_{V25}, a size of the horizontal projection feature map X_{H25} is N×2304, and a size of the vertical projection feature map X_{V25} is N×2304; through the map building block, each projection feature in the horizontal projection feature map and the vertical projection feature map is configured as a node, and an adjacency matrix M_{H} and an adjacency matrix M_{V} are constructed according to an adjacency relationship between any two nodes, wherein a size of the adjacency matrix M_{H} is N×N, and a size of the adjacency matrix M_{V} is N×N, and then a corresponding graph structure G_{H}={X_{H25},M_{H}} and a graph structure G_{V}={X_{V25},M_{V}} are formed according to the feature map X_{H25}, the feature map X_{V25}, the adjacency matrix M_{H}, and the adjacency matrix M_{V}.

In a possible embodiment, in step S2, the quality prediction module includes two graph convolutional networks with identical structure and non-shared structure and a hybrid prediction block, the two graph convolutional networks include a four-layer structure and the four-layer structure is connected in sequence, firstly, the graph structure G_{H}={X_{H25},M_{H}} is received and processed through the first graph convolutional network to obtain a feature map X_{GH1}, a feature map X_{GH2}, a feature map X_{GH3}, and a feature map X_{GH4}, and the graph structure G_{V}={X_{V25},M_{V}} is received and processed through the second graph convolutional network to obtain a feature map X_{GV1}, a feature map X_{GV2}, a feature map X_{GV3}, and a feature map X_{GV4}, secondly, through the hybrid prediction block, corresponding first processed feature maps are obtained by using average pooling and a fully connected layer with an output channel number of 1 on the feature map X_{GH1}, feature map X_{GH2}, feature map X_{GH3}, feature map X_{GV1}, feature map X_{GV2}, and feature map X_{GV3}, and corresponding second processed feature maps are obtained by using average pooling and a fully connected layer on the feature map X_{GH4} and feature map X_{GV4}, respectively, thirdly, the channel stitching is performed on each of the first processed feature maps and each of the second processed feature maps to obtain a hybrid feature map X_{HV}, wherein a size of the hybrid feature map X_{HV} is 1, and finally the hybrid feature map X_{HV} is passed through a fully connected layer with a number of input channels of 10, and a number of output channels of 1 to obtain the predict quality score S.

Compared with the prior art, after adopting the above technical solution, by dynamically fusing image features of the horizontal projection image and the vertical projection image extracted by two graph convolutional networks with non-shared weights, the feature representation ability of the no-reference point cloud quality assessment network model is enhanced, and the accuracy of the predict quality score is effectively improved.

In a possible embodiment, in step S2, for the first graph convolutional network, an input end of a first layer is configured as an input end of the first graph convolutional network to receive the graph structure G_{H}={X_{H25},M_{H}}, an output end of the first layer outputs the feature map X_{GH1}, an input end of a second layer receives the graph structure G_{H1}={X_{GH1},M_{H}}, an output end of the second layer outputs the feature map X_{GH2}, an input end of a third layer receives the graph structure G_{H2}={X_{GH2}M_{H}}, an output end of the third layer outputs the feature map X_{GH3}, an input end of a fourth layer receives the graph structure G_{H3}={X_{GH3},M_{H}}, and an output end of the fourth layer outputs the feature map X_{GH4}; wherein a size of the feature map X_{GH1} is N×512, a size of the feature map X_{GH2} is N×128, a size of the feature map X_{GH3} is N×32, and a size of the feature map X_{GH4} is N×1.

In a possible embodiment, in step S2, for the second graph convolutional network, an input end of a first layer is configured as an input end of the second graph convolutional network to receive the graph structure G_{V}={X_{V25},M_{V}}, an output end of the first layer outputs the feature map X_{GV1}, an input end of a second layer receives the graph structure G_{V1}={X_{GV1},M_{V}}, an output end of the second layer outputs the feature map X_{GV2}, an input end of a third layer receives the graph structure G_{V2}={X_{GV2},M_{V}}, an output end of the third layer outputs the feature map X_{GV3}, an input end of a fourth layer receives the graph structure G_{V3}={X_{GV3},M_{V}}, and an output end of the fourth layer outputs the feature map X_{GV4}; wherein a size of the feature map X_{GV1} is N×512, a size of the feature map X_{GV2} is N×128, a size of the feature map X_{GV3} is N×32, and a size of the feature map X_{GV4} is N×1.

In a possible embodiment, in step S2, the two graph convolutional networks include four graph convolutional blocks connected in sequence, an input end of a first graph convolutional block is configured as an input end of the graph convolutional network, an input end of a second graph convolutional block receives a feature map output by an output end of the first graph convolutional block, an input end of a third graph convolutional block receives a feature map output by an output end of the second graph convolutional block, an input end of a forth graph convolutional block receives a feature map output by an output end of the third graph convolutional block, and the feature maps output by output ends of the first graph convolutional block, second graph convolutional block, third graph convolutional block, and fourth graph convolutional block are configured as the output end of the graph convolutional network; wherein, the first graph convolutional block, second graph convolutional block, and third graph convolutional block have the same structure, and all include a graph convolutional layer, a batch normalization layer, and a Softplus activation function layer connected in sequence, and the fourth graph convolutional block only includes the graph convolutional layer and the Softplus activation function layer connected in sequence, wherein an input end of the graph convolutional layer is configured as an input end of the graph convolutional block where it is located, and an output end of the Softplus activation function layer is configured as an output end of the convolutional block where it is located; a number of input channels and output channels of the graph convolution layer in the first graph convolution block is 2304 and 512 respectively, a number of input channels and output channels of the graph convolution layer in the second graph convolution block is 512 and 128 respectively; a number of input channels and output channels of the graph convolution layer in the third graph convolution block is 128 and 32 respectively; and a number of input channels and output channels of the graph convolution layer in the fourth graph convolution block is 32 and 1 respectively.

### BRIEF DESCRIPTION OF THE DRAWINGS

FIG. 1 is a flowchart of the steps of the present disclosure;

FIG. 2 is a framework diagram of a no-reference point cloud quality assessment network of the present disclosure;

FIG. 3 is a framework diagram of a multi-layer attention perception module of the present disclosure.

FIG. 4 is a framework diagram of a multi-layer conversion module of the present disclosure.

FIG. 5 is a framework diagram of a graph convolutional network of the present disclosure;

FIG. 6 is a framework diagram of a hybrid prediction block of the present disclosure;

FIG. 7 is a first part of a scatter plot between objective prediction scores and subjective quality score of the 3D point cloud quality prediction method of the present disclosure and the existing point cloud quality prediction method on the Shanghai Jiao Tong University (SJTU) dataset;

FIG. 8 is a second part of a scatter plot between objective prediction scores and subjective quality score of the 3D point cloud quality prediction method of the present disclosure and the existing point cloud quality prediction method on the SJTU dataset;

FIG. 9 is a first part of a scatter plot between objective prediction scores and subjective quality score of the 3D point cloud quality prediction method of the present disclosure and the existing point cloud quality assessment method on the Waterloo Point Cloud (WPC) dataset;

FIG. 10 is a second part of a scatter plot between objective prediction scores and subjective quality score of the 3D point cloud quality prediction method of the present disclosure and the existing point cloud quality assessment method on the WPC dataset.

### DETAILED DESCRIPTION OF THE EMBODIMENTS

Firstly, it should be understood by those skilled in the art that these embodiments are merely intended to explain the technical principles of the present disclosure and are not intended to limit the scope of protection of the present disclosure. Those skilled in the art may make adjustments as necessary to suit specific applications.

The following is a further detailed description of the present disclosure with reference to the accompanying drawings and specific embodiments.

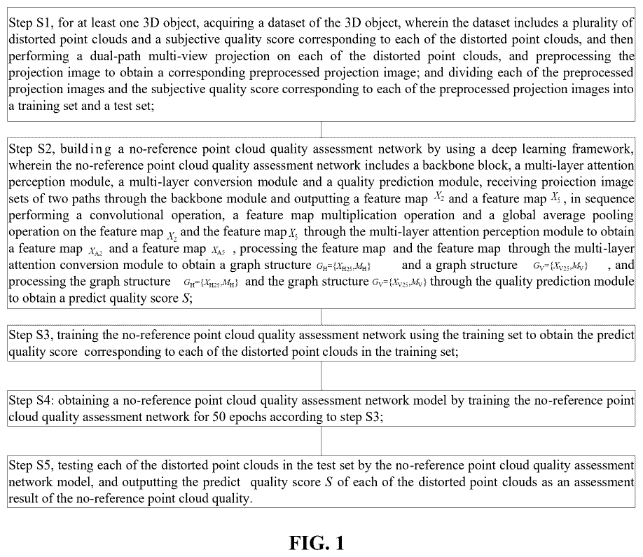

With reference to FIG. 1, the embodiment of the present disclosure discloses a 3D point cloud quality prediction method based on a graph convolutional neural network, including:

Step S1: a dataset is acquired, the dataset includes a variety of different types of point cloud data. The original sample of each point cloud data generate a variety of quality distorted point clouds by being compressed and noised to varying degrees, and each distorted point cloud has its subjective quality score; secondly, the dual-path multi-view projection is performed on each of the distorted point clouds in the dataset, the number of projection images obtained on each of the projection path is N, and then each of the projection images is preprocessed by size adjustment, cropping and normalization, so that the image size of the preprocessed projection image is H×W×C; thirdly, all the preprocessed projection images and their corresponding subjective quality scores are divided into training set and test set. The point cloud types that appeared in the training set will not reappear in the test set. In this embodiment, N=10, H=W=224, and C=3.

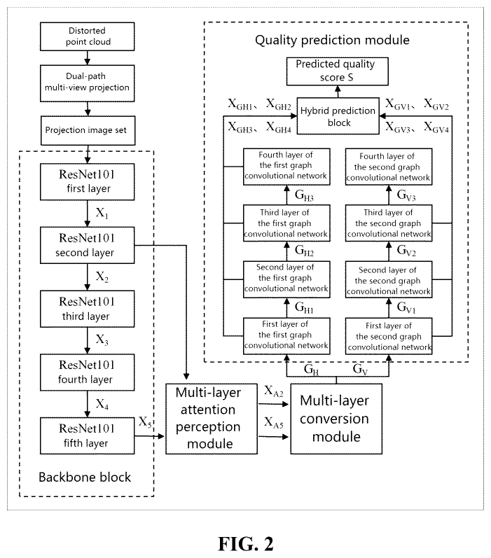

Step S2: the deep neural network is built as a no-reference point cloud quality assessment network by using the deep learning framework, as shown in FIG. 2, the network mainly includes a backbone block, a multi-layer attention perception module, a multi-layer conversion module and a quality prediction module; wherein,

The backbone module is the ResNet101 backbone network including a five-layer structure. The five-layer structures in the ResNet101 backbone network are connected in sequence. The input end of the first layer is configured as the input end of the backbone module and simultaneously receives the projection image sets of two paths, each of projection image sets includes the N preprocessed projection images with the size of H×W×C. The input end of the second layer of the ResNet101 backbone network receives the feature map output by the output end of the first layer of the ResNet101 backbone network. The input end of the third layer of the ResNet101 backbone network receives the feature map output by the output end of the second layer of the ResNet101 backbone network. The input end of the fourth layer of the ResNet101 backbone network receives the feature map output by the output end of the third layer of the ResNet101 backbone network. The input end of the fifth layer of the ResNet101 backbone network receives the feature map output by the output end of the fourth layer of the ResNet101 backbone network. The output ends of the second layer and fifth layer are configured as the multi-level output ends of the backbone module. The feature map output by the output end of the first layer of the ResNet101 backbone network is denoted as X₁, the input end of the second layer receives the feature map X₁ output by the output end of the first layer of the ResNet101 backbone network, the feature map output by the output end of the second layer of the ResNet101 backbone network is denoted as X₂, the input end of the third layer receives the feature map X₂ output by the output end of the second layer of the ResNet101 backbone network, the feature map output by the output end of the third layer of the ResNet101 backbone network is denoted as X₃, the input end of the fourth layer receives the feature map X₃ output by the output end of the third layer of the ResNet101 backbone network, the feature map output by the output end of the fourth layer of the ResNet101 backbone network is denoted as X₄, the input end of the fifth layer receives the feature map X₄ output by the output end of the fourth layer of the ResNet101 backbone network, and the feature map output by the output end of the fifth layer of the ResNet101 backbone network is denoted as X₅. Wherein the size of the feature map X₁ output by the output end of the first layer of the ResNet101 backbone network is

$$2 N \times \frac{H}{4} \times \frac{W}{4} \times 64 ,$$

the size of the feature map X₂ output by the output end of the second layer of the ResNet101 backbone network is

$$2 N \times \frac{H}{4} \times \frac{W}{4} \times 256 ,$$

the size of the feature map X₃ output by the output end of the third layer of the ResNet101 backbone network is

$$2 N \times \frac{H}{8} \times \frac{W}{8} \times 512 ,$$

the size of the feature map X₄ output by the output end of the forth layer of the ResNet101 backbone network is

$$2 N \times \frac{H}{16} \times \frac{W}{16} \times 1024 ,$$

and the size of the feature map X₅ output by the output end of the fifth layer of the ResNet101 backbone network is

$$2 N \times \frac{H}{32} \times \frac{W}{32} \times 2048.$$

The ResNet101 backbone network is an existing structural framework, and its network structure has been publicly disclosed, as described in the reference: K. He, X. Zhang, S. Ren and J. Sun, “Deep Residual Learning for Image Recognition,” 2016 IEEE Conference on Computer Vision and Pattern Recognition (CVPR), pp. 770-778, 2016 has documented the ResNet101 backbone network.

Step S3: the no-reference point cloud quality assessment network is trained using the training set. After each training epoch, the no-reference point cloud quality assessment network outputs the predict quality score for each distorted point cloud in the training set, denoted as S, and then the network loss is calculated, denoted as L,

$$L = \frac{1}{n} {\sum }_{i = 0}^{n} \vert S - GT \vert ;$$

where n denotes the batch size, GT denotes the subjective quality score of each distorted point cloud in the training set, the initial learning rate with the Adam optimizer is 1×10⁻³ , the learning rate is decayed to 0.5 times the original value every 10 epochs, and a batch size of 32 is used.

Step S4: according to the process of step S3, a total of 50 epochs are trained, and the no-reference point cloud quality assessment network is obtained.

Step S5: each of the distorted point clouds in the test set is tested by the no-reference point cloud quality assessment network model, and based on the no-reference point cloud quality assessment network model, the predict quality score corresponding to each of the distorted point clouds in the test set is output as the assessment result of the no-reference point cloud quality.

With reference to FIG. 1, in Step 1, the process of preprocessing a distorted point cloud is as follows: firstly, existing technology is used to perform dual-path multi-view projection on the distorted point cloud, the number of projection images obtained on each of the projection path is N, and then each of the projection images is preprocessed by size adjustment, cropping and normalization to obtain the preprocessed projection image with an image size of H×W×C. Secondly, the normalization processing is performed on each of the scaled projection images, pixel values of all pixels in the R channel of the scaled projection image are normalized to the mean value of 0.485 and the variance of 0.229, pixel values of all pixels in the G channel are normalized to the mean value of 0.456 and the variance of 0.224, and pixel values of all pixels in the B channel are normalized to the mean value of 0.406 and the variance of 0.225. Since the input of the deep neural network typically has a fixed form, it is necessary to preprocess the input projection image. Specifically, normalization processing is performed on the projection images to improve the training efficiency of subsequent models,

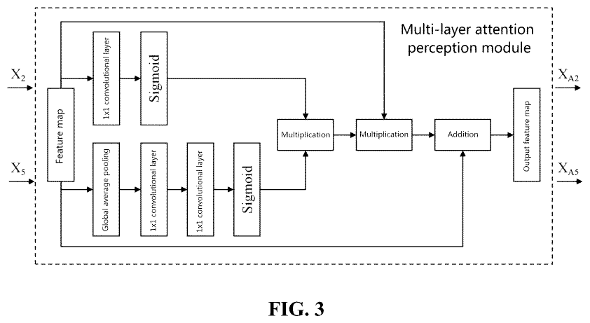

With reference to FIG. 3, the multi-level attention perception module is performed in two branches, specifically:
(1) The first branch takes the the feature map X₂ output by the output end of the second layer of the ResNet101 backbone network as the input, the channel size compression is achieved by X₂ passes through the convolutional layer with the convolutional kernel size of 1, the stride of 1, the padding of 0, the number of input channels of 256, and the number of output channels of 1, and the feature value range is mapped to [0, 1] by applying the Sigmoid activation function to obtain the attention feature map A₂₁, wherein the size of the attention feature map A₂₁ is

$$2 N \times \frac{H}{4} \times \frac{W}{4} \times 1 ;$$

then X₂ performs the global average pooling of spatial dimensions through the global average pooling layer, and then passing the convolutional layer with the convolutional kernel size of 1, the stride of 1, the padding of 0, the number of input channels of 256, and the number of output channels of 16, and the convolutional layer with the convolutional kernel size of 1, the stride of 1, the padding of 0, the number of input channels of 16, and the number of output channels of 256, and the feature value range is mapped to [0, 1] by applying the Sigmoid activation function to obtain the attention feature map A₂₂, wherein the size of the attention feature map A₂₂ is 2N×1×1×256; then the two attention feature maps are multiplied to obtain the mixed attention feature map A₂, wherein the size of the mixed attention feature map A₂ is

$$2 N \times \frac{H}{4} \times \frac{W}{4} \times 256 ;$$

and the mixed attention feature map A₂ is multiplied with the original input feature map X₂ and added to the feature map X₂ by the residual connection, and the global average pooling operation is performed to obtain the feature map X_{A2}, wherein the size of the feature map X_{A2} is 2N×256;
(2) The second branch takes the the feature map X₅ output by the output end of the second layer of the ResNet101 backbone network as the input, the channel size compression is achieved by X₅ passes through the convolutional layer with the convolutional kernel size of 1, the stride of 1, the padding of 0, the number of input channels of 2048, and the number of output channels of 1, and the feature value range is mapped to [0, 1] by applying the Sigmoid activation function to obtain the attention feature map A₅₁, wherein the size of the attention feature map A₅₁ is

$$N \times \frac{H}{32} \times \frac{W}{32} \times 1 ;$$

then X₅ performs the global average pooling of spatial dimensions through the global average pooling layer, and then passing the convolutional layer with the convolutional kernel size of 1, the stride of 1, the padding of 0, the number of input channels of 2048, and the number of output channels of 128, and the convolutional layer with the convolutional kernel size of 1, the stride of 1, the padding of 0, the number of input channels of 128, and the number of output channels of 2048, and the feature value range is mapped to [0, 1] by applying the Sigmoid activation function to obtain the attention feature map A₅₂, wherein the size of the attention feature map A₅₂ is 2N×1×1×2048; then the two attention feature maps are multiplied to obtain the mixed attention feature map A₅, wherein the size of the mixed attention feature map A₅ is

$$2 N \times \frac{H}{32} \times \frac{W}{32} \times 2 \; 048 ;$$

and the mixed attention feature map A₅ is multiplied with the original input feature map X₅ and added to the feature map X₅ by the residual connection, and the global average pooling operation is performed to obtain the feature map X_{A5}, wherein the size of the feature map X_{A5} is 2N×2048.

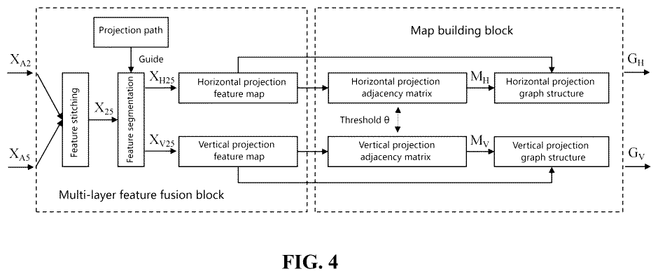

With reference to FIG. 4, the multi-layer conversion module is mainly composed of a multi-layer feature fusion block and a map building block; the channel stitching is performed on the feature map X_{A2} and the feature map X_{A5} through the multi-layer feature fusion block, and the obtained feature map is denoted as X₂₅, the size of the feature map X₂₅ is 2N×2304, then the feature map X₂₅ is segmented according to the projection path, the obtained the horizontal projection feature map is denoted as X_{H25} and the obtained vertical projection feature map is denoted as X_{V25}, the size of X_{H25} is N×2304, and the size of X_{V25} is N×2304; the map building block represents each of projection image feature as a node in the map, and constructs an adjacency matrix based on the adjacency relationship between any two nodes. If the rotation step between the two projection images is less than the threshold θ, the two projection images are considered to be spatially connected, the adjacency matrices are denoted as M_{H} and M_{V}, respectively, the size of M_{H} is N×N, and the size of M_{V} is N×N, finally the corresponding graph structure G_{H}={X_{H25},M_{H}} and the graph structure G_{V}={X_{V25},M_{V}} are formed according to the feature maps X_{H25} and X_{V25}, and the adjacency matrices M_{H} and M_{V}. On this context, according to the nonlinear relation and global dependence between multi-view projection images of different projection paths, the feature map is converted into a corresponding graph structure.

With reference to FIG. 2, the quality prediction module is mainly composed of two graph convolutional networks with identical structure and non-shared structure and the hybrid prediction block, and the four-layer structure of the graph convolutional network is connected in sequence. The input end of the first layer of the first graph convolutional network is configured as the input end of the graph convolutional network to receive the graph structure G_{H}={X_{H25},M_{H}}, the feature map output by the output end of the first layer is denoted as X_{GH1}, the input end of the second layer receives the graph structure G_{H1}={X_{GH1},M_{H}} output by the output end of the first layer of the graph convolutional network, the feature map output by the output end of the second layer is denoted as X_{GH2}, the input end of the third layer receives the graph structure G_{H2}={X_{GH2},M_{H}} output by the output end of the second layer of the graph convolutional network, the feature map output by the output end of the third layer is denoted as X_{GH3}, the input end of the fourth layer receives the graph structure X_{GH3} output by the output end of the third layer of the graph convolutional network, and the feature map output by the output end of the fourth layer is denoted as X_{GH4}; wherein the size of the feature map X_{GH1} output by the output end of the first layer of the first graph convolutional network is N×512, the size of the feature map X_{GH2} output by the output end of the second layer of the first graph convolutional network is N×128, the size of the feature map X_{GH3} output by the output end of the third layer of the first graph convolutional network is N×32, the size of the feature map X_{GH4} output by the output end of the forth layer of the first graph convolutional network is N×1. The input end of the first layer of the second graph convolutional network is configured as the input end of the graph convolutional network to receive the graph structure G_{V}={X_{V25},M_{V}}, and the remaining operations are the same as above; wherein the size of the feature map X_{GV1} output by the output end of the first layer of the second graph convolutional network is N×512, the size of the feature map X_{GV2} output by the output end of the second layer of the second graph convolutional network is N×128, the size of the feature map X_{GV3} output by the output end of the third layer of the second graph convolutional network is N×32, the size of the feature map X_{GV4} output by the output end of the forth layer of the second graph convolutional network is N×1; the hybrid prediction block uses average pooling and the fully connected layer with an output channel number of 1 on the X_{GH1}, X_{GH2}, X_{GH3}, X_{GV1}, X_{GV2}, and X_{GV3}, and then performs the average pooling and the fully connected layer on X_{GH4} and X_{GV4}, respectively, and then the channel stitching is performed on these feature maps, the obtained hybrid feature map is denoted as X_{HV}, the size of the hybrid feature map X_{HV} is 1, and finally X_{HV} passes through the fully connected layer with the number of input channels of 10, and the number of output channels of 1 to obtain the final predict quality score S.

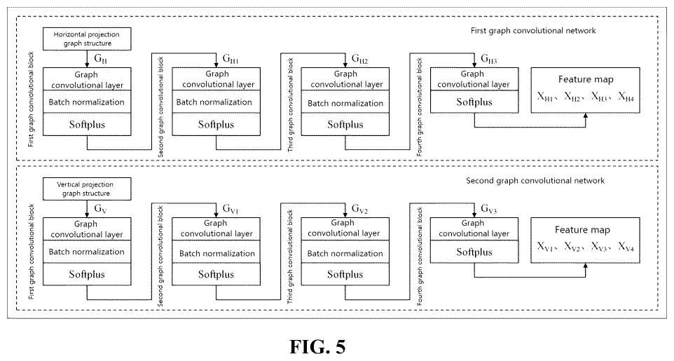

With reference to FIG. 5, in step S2, each of the graph convolutional networks includes four graph convolutional blocks, the input end of the first graph convolutional block is configured as the input end of the graph convolutional network, the input end of the second graph convolutional block receives the feature map output by the output end of the first graph convolutional block, the input end of the third graph convolutional block receives the feature map output by the output end of the second graph convolutional block, the input end of the forth graph convolutional block receives the feature map output by the output end of the third graph convolutional block, and the feature maps output by output ends of the first graph convolutional block, second graph convolutional block, third graph convolutional block, and fourth graph convolutional block are the multi-layer feature maps output by the output end of the graph convolutional network; wherein, the first graph convolutional block, second graph convolutional block, and third graph convolutional block have the same structure, and all include the graph convolutional layer, the batch normalization layer, and the Softplus activation function layer connected in sequence, and the fourth graph convolutional block only includes the graph convolutional layer and the Softplus activation function layer connected in sequence, wherein the input end of the graph convolutional layer is configured as the input end of the graph convolutional block where it is located, and the output end of the Softplus activation function layer is configured as the output end of the convolutional block where it is located; the number of input channels and output channels of the graph convolution layer in the first graph convolution block is 2304 and 512 respectively, and the input end of the graph convolutional layer in the first graph convolutional block receives Y₁ and the adjacency matrix M, and the feature map output by the output end of the Softplus activation function layer in the first graph convolutional block is denoted as Y′₁, wherein the size of Y′₁ is N×512; the number of input channels and output channels of the graph convolution layer in the second graph convolution block is 512 and 128 respectively; and the input end of the graph convolutional layer in the first graph convolutional block receives Y₂ and the adjacency matrix M, and the feature map output by the output end of the Softplus activation function layer in the second graph convolutional block is denoted as Y′₂, wherein the size of Y′₂ is N×128; the number of input channels and output channels of the graph convolution layer in the third graph convolution block is 128 and 32 respectively; and the input end of the graph convolutional layer in the first graph convolutional block receives Y₃ and the adjacency matrix M, and the feature map output by the output end of the Softplus activation function layer in the third graph convolutional block is denoted as Y′₃, wherein the size of Y′₃ is N×32; and the number of input channels and output channels of the graph convolution layer in the fourth graph convolution block is 32 and 1 respectively, and the input end of the graph convolutional layer in the first graph convolutional block receives Y₄ and the adjacency matrix M, and the feature map output by the output end of the Softplus activation function layer in the forth graph convolutional block is denoted as Y′₄, where the size of Y′₄ is N×1.

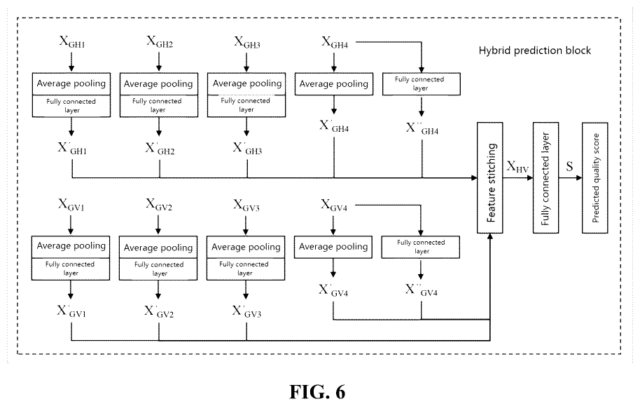

With reference to FIG. 6, in step S2, the hybrid prediction block is mainly divided into two parts. In the first part, the average pooling and the fully connected layer with an output channel number of 1 are used on the horizontal projection feature maps X_{GH1}, X_{GH2}, and X_{GH3}, and the vertical projection feature maps X_{GV1}, X_{GV2}, and X_{GV3}, the output feature maps are denoted as X′_{GH1}, X′_{GH2}, X′_{GH3}, X′_{GV1}, X′_{GV2}, X′_{GV3}, X′_{GV4}, X″_{GH4}, and X″_{GV4}, the feature stitching is performed on the above the output feature maps, and the obtained mixed feature map is denoted as X_{HV}, wherein the size of X_{HV} is 10×1; X_{HV} passes through a fully connected layer with a number of input channels of 10 and a number of output channels of 1 to obtain the final predict quality score S.

With reference to FIG. 1, in order to further verify the feasibility and effectiveness of the method of the present disclosure, an experiment is conducted on the method of the present disclosure.

In the experiment, the public point cloud quality data set is directly selected for training and testing, including SJTU and WPC. In the experiment, the K-fold cross-validation strategy is adopted. For each point cloud quality dataset,

$$\frac{K - 1}{K}$$

distorted samples are randomly selected as the training set, and the remaining point clouds are used as the test set, and the final result can be obtained by averaging K times of performance.

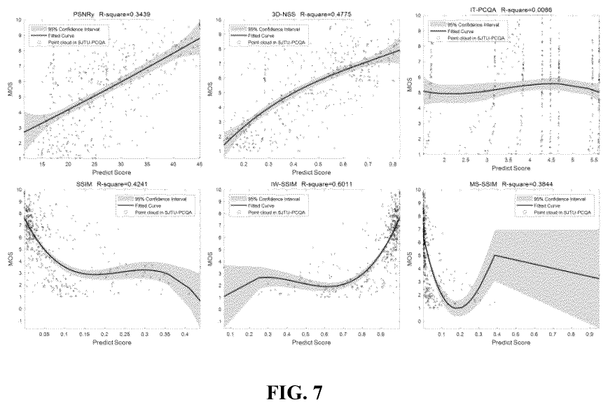

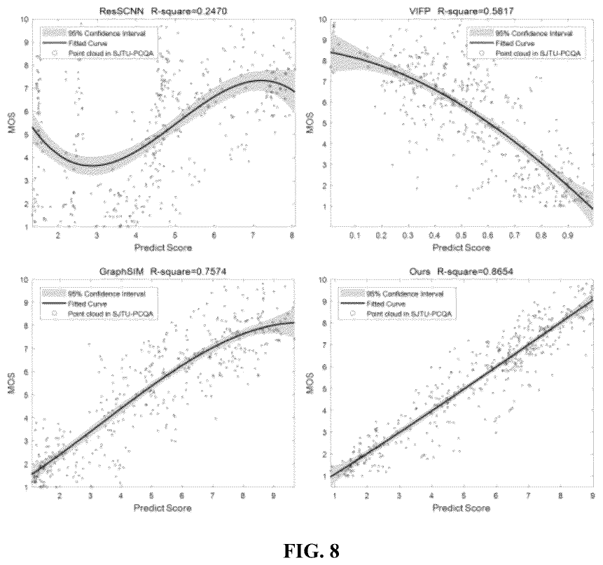

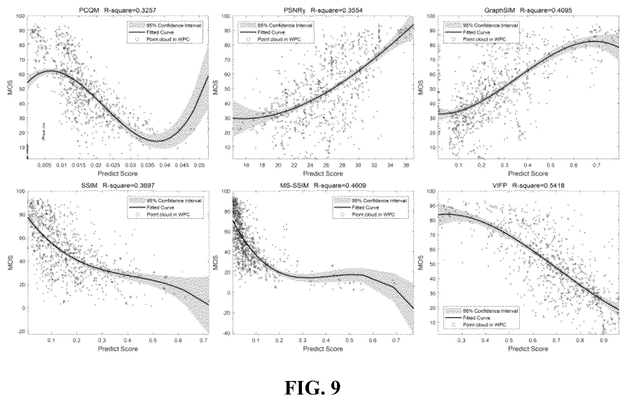

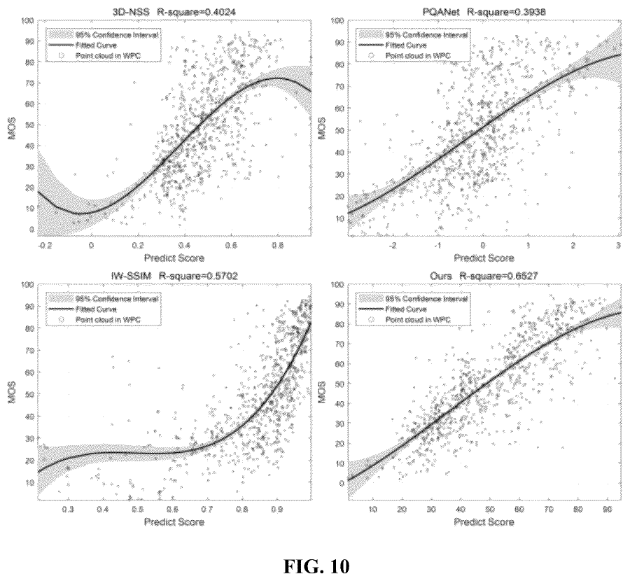

Four indicators are used to assess and compare different point cloud quality assessment methods, including Spearman's Rank Correlation Coefficient (SRCC), Pearson's Linear Correlation Coefficient (PLCC), Kendall rank correlation coefficient (KRCC), and root mean square error (RMSE); specifically, SRCC and KRCC are mainly used to assess the monotonicity of the model and ensure that the model can maintain a consistent trend when variables change; PLCC and RMSE are used to assess the accuracy of the model and ensure that the prediction results are as close as possible to the actual values; FIG. 7 and FIG. 8 are scatter plots between objective prediction scores and subjective quality score of the 3D point cloud quality prediction method of the present disclosure and the existing point cloud quality prediction method on the SJTU dataset; FIG. 9 and FIG. 10 are scatter plots between objective prediction scores and subjective quality score of the 3D point cloud quality prediction method of the present disclosure and the existing point cloud quality assessment method on the WPC dataset. Table 1 below gives a quantitative comparison of assessment indicators between the method of the present disclosure and common point cloud quality assessment methods on the SJTU and WPC datasets:

TABLE 1
Quantitative comparison of assessment indicator between
the method of the present disclosure and common point cloud
quality assessment methods on SJTU and WPC datasets

| | SJTU | | | | WPC | | | |
|---|---|---|---|---|---|---|---|---|
| Metric | SRCC | PLCC | KRCC | RMSE | SRCC | PLCC | KRCC | RMSE |
| PSNR_{MSE, p2po} | 0.6002 | 0.7622 | 0.4917 | 1.4382 | 0.1607 | 0.2673 | 0.1147 | 20.6947 |
| PSNR_{MSE, p2pl} | 0.5505 | 0.7381 | 0.4375 | 1.5357 | 0.1182 | 0.2879 | 0.0851 | 21.1898 |
| PSNR_{HF, p2po} | 0.6744 | 0.7737 | 0.5217 | 1.4481 | 0.0557 | 0.3555 | 0.0384 | 20.8197 |
| PSNR_{HF, p2pl} | 0.6208 | 0.7286 | 0.4701 | 1.6000 | 0.0989 | 0.3263 | 0.0681 | 21.1100 |
| AS_{Mean} | 0.5317 | 0.5297 | 0.3723 | 2.7129 | 0.2484 | 0.3397 | 0.1801 | 21.5013 |
| AS_{RMS} | 0.5653 | 0.7156 | 0.4144 | 1.6550 | 0.2479 | 0.3347 | 0.1802 | 21.5325 |
| AS_{MSE} | 0.5472 | 0.5115 | 0.3865 | 2.6431 | 0.2484 | 0.3397 | 0.1801 | 21.5013 |
| PSNR_{Y} | 0.7871 | 0.8124 | 0.6116 | 1.3222 | 0.5823 | 0.6166 | 0.4164 | 17.9001 |
| PCQM | 0.7748 | 0.8301 | 0.6152 | 1.2978 | 0.5504 | 0.6162 | 0.4409 | 17.9027 |
| PointSSIM | 0.7051 | 0.7422 | 0.5321 | 1.5601 | 0.4639 | 0.5225 | 0.3394 | 19.3863 |
| GraphSIM | 0.8853 | 0.9158 | 0.7063 | 0.9462 | 0.6217 | 0.6833 | 0.4562 | 16.5107 |
| SSIM | 0.8667 | 0.8868 | 0.6988 | 1.0454 | 0.6483 | 0.6690 | 0.4685 | 16.8841 |
| MS-SSIM | 0.8738 | 0.8930 | 0.7069 | 1.0091 | 0.7179 | 0.7349 | 0.5385 | 15.3341 |
| IW-SSIM | 0.8638 | 0.8932 | 0.6934 | 1.0268 | 0.7608 | 0.7688 | 0.5707 | 14.5453 |
| VIFP | 0.8624 | 0.8977 | 0.6934 | 1.0173 | 0.7426 | 0.7508 | 0.5575 | 15.0328 |
| PCMRR | 0.5622 | 0.6699 | 0.4091 | 1.7589 | 0.3605 | 0.3926 | 0.2543 | 20.9203 |
| 3D-NSS | 0.7819 | 0.7813 | 0.6023 | 1.7740 | 0.6309 | 0.6284 | 0.4573 | 18.1706 |
| ResSCNN | 0.8328 | 0.8865 | 0.6514 | 1.0728 | 0.4362 | 0.4531 | 0.2987 | 20.2591 |
| PQANet | 0.7593 | 0.7998 | 0.5796 | 1.3773 | 0.6368 | 0.6671 | 0.4684 | 16.6758 |
| IT-PCQA | 0.8286 | 0.8605 | 0.6453 | 1.1686 | 0.4329 | 0.4870 | 0.3006 | 19.896 |
| Present | 0.9108 | 0.9301 | 0.7546 | 0.8691 | 0.8054 | 0.8091 | 0.6246 | 13.3405 |
| invention | | | | | | | | |

Wherein a higher correlation coefficient and a lower RMSE represent better performance.

In the description of the present disclosure, the terms “an embodiment,” “some embodiments,” “in this embodiment,” “a specific example,” or “some examples” refer to specific features, structures, materials, or characteristics described in conjunction with the embodiment or example, which are included in at least one embodiment or example of the present disclosure. In this specification, the exemplary statements of the above terms are not necessarily directed to the same embodiment or example. Furthermore, the specific features, structures, materials, or characteristics described may be appropriately combined in any one or more embodiments or examples. Additionally, without contradiction, those skilled in the art may combine and combine the different embodiments or examples described in this specification and the features of different embodiments or examples.

In view of the foregoing, the above description is only a specific embodiment of the present disclosure, and the scope of protection of the present disclosure is not limited thereto. Those skilled in the art may easily conceive of changes or replacements within the technical scope disclosed in the present disclosure, and such changes or replacements should be included within the scope of protection of the present disclosure. Therefore, the scope of protection of the present disclosure should be determined by the scope of protection of the claims.

What is claimed is:

1. A 3D point cloud quality prediction method based on a graph convolutional neural network, comprising the following steps:
step S1, for at least one 3D object, acquiring a dataset of the 3D object, wherein the dataset comprises a plurality of distorted point clouds and a subjective quality score corresponding to each of the distorted point clouds, and then performing a dual-path multi-view projection on each of the distorted point clouds, and preprocessing the projection image to obtain a corresponding preprocessed projection image; and dividing each of the preprocessed projection images and the subjective quality score corresponding to each of the preprocessed projection images into a training set and a test set;
step S2, building a no-reference point cloud quality assessment network by using a deep learning framework, wherein the no-reference point cloud quality assessment network comprises a backbone block, a multi-layer attention perception module, a multi-layer conversion module and a quality prediction module;
receiving projection image sets of two paths through the backbone module and outputting a feature map X₂ and a feature map X₅,
performing a convolutional operation, a feature map multiplication operation and a global average pooling operation in sequence on the feature map X₂ and the feature map X₅ through the multi-layer attention perception module to obtain a feature map X_{A2} and a feature map X_{A5},
processing the feature map X_{A2} and the feature map X_{A5} through the multi-layer attention conversion module to obtain a graph structure G_{H}={X_{H25},M_{H}} and a graph structure G_{V}={X_{V25},M_{V}}, and
processing the graph structure G_{H}={X_{H25},M_{H}} and the graph structure G_{V}={X_{V25},M_{V}} through the quality prediction module to obtain a predict quality score S.
step S3, training the no-reference point cloud quality assessment network using the training set to obtain the predict quality score S corresponding to each of the distorted point clouds in the training set;
step S4: obtaining a no-reference point cloud quality assessment network model by training the no-reference point cloud quality assessment network for a plurality of epochs according to step S3; and
step S5, testing each of the distorted point clouds in the test set by the no-reference point cloud quality assessment network model, and outputting the predict quality score S of each of the distorted point clouds as an assessment result of the no-reference point cloud quality;
wherein in step S2, the quality prediction module comprises two graph convolutional networks with identical structure and non-shared structure and a hybrid prediction block, and the two graph convolutional networks comprise a four-layer structure and the four-layer structure is connected in sequence;
wherein the graph structure G_{H}={X_{H25},M_{H}} is first received and processed through the first graph convolutional network to obtain a feature map X_{GH1}, a feature map X_{GH2}, a feature map X_{GH3}, and a feature map X_{GH4}, and wherein the graph structure G_{V}={X_{V25},M_{V}} is received and processed through the second graph convolutional network to obtain a feature map X_{GV1}, a feature map X_{GV2}, a feature map X_{GV3}, and a feature map X_{GV4};
wherein, through the hybrid prediction block, corresponding first processed feature maps are obtained by using average pooling and a fully connected layer with an output channel number of 1 on the feature map X_{GH1}, feature map X_{GH2}, feature map X_{GH3}, feature map X_{GV1}, feature map X_{GV2}, and feature map X_{GV3}, and corresponding second processed feature maps are obtained by using average pooling and the fully connected layer on the feature map X_{GH4} and feature map X_{GV4}, respectively;
wherein channel stitching is performed on each of the first processed feature maps and each of the second processed feature maps to obtain a hybrid feature map X_{HV}, wherein a size of the hybrid feature map X_{HV} is 1, and a final hybrid feature map X_{HV} is passed through a fully connected layer with a number of input channels of 10, and a number of output channels of 1 to obtain the predict quality score S;
wherein in step S2, the two graph convolutional networks comprise four graph convolutional blocks connected in sequence, and wherein an input end of a first graph convolutional block is configured as an input end of the graph convolutional network, an input end of a second graph convolutional block receives a feature map output by an output end of the first graph convolutional block, an input end of a third graph convolutional block receives a feature map output by an output end of the second graph convolutional block, an input end of a forth graph convolutional block receives a feature map output by an output end of the third graph convolutional block, and the feature maps output by output ends of the first graph convolutional block, second graph convolutional block, third graph convolutional block, and fourth graph convolutional block are configured as the output end of the graph convolutional network;
wherein, the first graph convolutional block, second graph convolutional block, and third graph convolutional block have the same structure, and all comprise a graph convolutional layer, a batch normalization layer, and a Softplus activation function layer connected in sequence, and the fourth graph convolutional block only comprises the graph convolutional layer and the Softplus activation function layer connected in sequence;
wherein an input end of the graph convolutional layer is configured as an input end of the graph convolutional block where it is located, and an output end of the Softplus activation function layer is configured as an output end of the convolutional block where it is located;
wherein a number of input channels and output channels of the graph convolution layer in the first graph convolution block is 2304 and 512 respectively; a number of input channels and output channels of the graph convolution layer in the second graph convolution block is 512 and 128 respectively; a number of input channels and output channels of the graph convolution layer in the third graph convolution block is 128 and 32 respectively; and a number of input channels and output channels of the graph convolution layer in the fourth graph convolution block is 32 and 1 respectively.

2. The 3D point cloud quality prediction method according to claim 1, wherein in step S1, the dual-path multi-view projection is performed on each of the distorted point clouds in the dataset, the number of projection images obtained on each of the projection path is N, and then each of the projection images is preprocessed by size adjustment, cropping and normalization to obtain the preprocessed projection image with an image size of H×W×C.

3. The 3D point cloud quality prediction method according to claim 2, wherein in step S1, the process of preprocessing each of the projection images comprises:
performing the size adjustment and cropping on each of the projection images;
scaling the size of each of the projection images to H×W×C;
performing the normalization processing on each of the scaled projection images;
normalizing pixel values of all pixels in a R channel of the scaled projection image to a mean value of 0.485 and a variance of 0.229;
normalizing pixel values of all pixels in a G channel to a mean value of 0.456 and a variance of 0.224; and
normalizing pixel values of all pixels in a B channel to a mean value of 0.406 and a variance of 0.225.

4. The 3D point cloud quality prediction method according to claim 1, wherein in step S2, the backbone module is a ResNet101 backbone network comprising a five-layer structure, and the five-layer structure is connected in sequence;
wherein an input end of a first layer is configured as an input end of the backbone module and simultaneously receives the projection image sets of two paths, wherein each of projection image sets comprises the N preprocessed projection images with the size of H×W×C, and output ends of a second layer and a fifth layers are configured as multi-layer output ends of the backbone module;
wherein the output end of the first layer outputs a feature map X₁, an input end of the second layer receives the feature map X₁, the output end of the second layer outputs a feature map X₂, an input end of a third layer receives the feature map X₂, an output end of the third layer outputs a feature map X₃, an input end of a fourth layer receives the feature map X₃, an output end of the fourth layer outputs a feature map X₄, an input end of the fifth layer receives the feature map X₄, and the output end of the fifth layer outputs a feature map X₅;
wherein a size of the feature map X₁ is
$$2 N \times \frac{H}{4} \times \frac{W}{4} \times 64 ;$$
a size of the feature map X₂ is
$$2 N \times \frac{H}{4} \times \frac{W}{4} \times 256 ;$$
a size of the feature map X₃ is
$$2 N \times \frac{H}{8} \times \frac{W}{8} \times 512 ;$$
a size of the feature map X₄ is
$$2 N \times \frac{H}{16} \times \frac{W}{16} \times 1024 ;$$
and
a size of the feature map X₅ is
$$2 N \times \frac{H}{32} \times \frac{W}{32} \times 2048 .$$

5. The 3D point cloud quality prediction method according to claim 1, wherein in step S2, the multi-layer attention perception module obtains the feature map X_{A2} and the feature map X_{A5} through two branches, wherein the execution step of a first branch comprises:
taking the feature map X₂ as input, performing a channel size compression through a convolutional layer with a convolutional kernel size of 1, a stride of 1, a padding of 0, a number of input channels of 256, and a number of output channels of 1, and mapping a feature value range to [0, 1] by applying a Sigmoid activation function to obtain an attention feature map A₂₁, wherein a size of the attention feature map A₂₁ is
$$2 N \times \frac{H}{4} \times \frac{W}{4} \times 1 ;$$
taking the feature map X₂ as input, performing a global average pooling of spatial dimensions through a global average pooling layer, and then sequentially passing a convolutional layer with a convolutional kernel size of 1, a stride of 1, a padding of 0, a number of input channels of 256, and a number of output channels of 16, and a convolutional layer with a convolutional kernel size of 1, a stride of 1, a padding of 0, a number of input channels of 16, and a number of output channels of 256, and mapping the feature value range to [0, 1] by applying the Sigmoid activation function to obtain an attention feature map A₂₂, wherein a size of the attention feature map A₂₂ is 2N×1×1×256;
multiplying the attention feature map A₂₁ with the attention feature map A₂₂ to obtain a mixed attention feature map A₂, wherein a size of the mixed attention feature map A₂ is
$$2 N \times \frac{H}{4} \times \frac{W}{4} \times 256 ;$$
multiplying the mixed attention feature map A₂ with the feature map X₂ and adding to the feature map X₂ by a residual connection; and
performing a global average pooling operation to obtain a feature map X_{A2}, wherein a size of the feature map X_{A2} is 2N×256;
wherein the executing step of a second branch comprises:
taking the feature map X₅ as input, performing a channel size compression through a convolutional layer with a convolutional kernel size of 1, a stride of 1, a padding of 0, a number of input channels of 2048, and a number of output channels of 1, and mapping a feature value range to [0, 1] by applying a Sigmoid activation function to obtain an attention feature map A₅₁, wherein a size of the attention feature map A₅₁ is
$$2 N \times \frac{H}{32} \times \frac{W}{32} \times 1 ;$$
taking the feature map X₅ as input, performing a global average pooling of spatial dimensions through a global average pooling layer, and then sequentially passing a convolutional layer with a convolutional kernel size of 1, a stride of 1, a padding of 0, a number of input channels of 2048, and a number of output channels of 128, and a convolutional layer with a convolutional kernel size of 1, a stride of 1, a padding of 0, a number of input channels of 128, and a number of output channels of 2048, and mapping the feature value range to [0, 1] by applying the Sigmoid activation function to obtain an attention feature map A₅₂, wherein a size of the attention feature map A₅₂ is 2N×1×1×2048;
multiplying the attention feature map A₅₁ with the attention feature map A₅₂ to obtain a mixed attention feature map A₅, wherein a size of the mixed attention feature map
$${A}_{5} is 2 N \times \frac{H}{32} \times \frac{W}{32} \times 2 \; 048 ;$$
multiplying the mixed attention feature map A₅ with the feature map X₅ and adding to the feature map X₅ by the residual connection; and
performing a global average pooling operation to obtain a feature map X_{A5}, wherein a size of the feature map X_{A5} is 2N×2048;

6. The 3D point cloud quality prediction method according to claim 1, wherein in step S2, the multi-layer conversion module comprises a multi-layer feature fusion block and a map building block,
wherein a channel stitching is performed on the feature map X_{A2} and the feature map X_{A5} through the multi-layer feature fusion block to obtain a feature map X₂₅,
wherein a size of the feature map X₂₅ is 2N×2304, the feature map X₂₅ is segmented according to the projection path of dual-path multi-view projection to obtain a horizontal projection feature map X_{H25} and a vertical projection feature map X_{V25};
wherein a size of the horizontal projection feature map X_{H25} is N×2304, and a size of the vertical projection feature map X_{V25} is N×2304;
wherein, through the map building block, each projection feature in the horizontal projection feature map and the vertical projection feature map is configured as a node, and an adjacency matrix M_{H} and an adjacency matrix M_{V} are constructed according to an adjacency relationship between any two nodes;
wherein a size of the adjacency matrix M_{H} is N×N, and a size of the adjacency matrix M_{V} is N×N, and then a corresponding graph structure G_{H}={X_{H25},M_{H}} and a graph structure G_{V}={X_{V25},M_{V}} are formed according to the feature map X_{H25}, the feature map X_{V25}, the adjacency matrix M_{H}, and the adjacency matrix M_{V}.

7. The 3D point cloud quality prediction method according to claim 1, wherein in step S2, for the first graph convolutional network, an input end of a first layer is configured as an input end of the first graph convolutional network to receive the graph structure G_{H}={X_{H25},M_{H}}, an output end of the first layer outputs the feature map X_{GH1}, an input end of a second layer receives a graph structure G_{H1}={X_{GH1},M_{H}}, an output end of the second layer outputs the feature map X_{GH2}, an input end of a third layer receives a graph structure G_{H2}={X_{GH2},M_{H}}, an output end of the third layer outputs the feature map X_{GH3}, an input end of a fourth layer receives a graph structure G_{H3}={X_{GH3},M_{H}}, and an output end of the fourth layer outputs the feature map X_{GH4};
wherein a size of the feature map X_{GH1} is N×512;
a size of the feature map X_{GH2} is N×128;
a size of the feature map X_{GH3} is N×32; and
a size of the feature map X_{GH4} is N×1.

8. The 3D point cloud quality prediction method according to claim 1, wherein in step S2, for the second graph convolutional network, an input end of a first layer is configured as an input end of the second graph convolutional network to receive the graph structure G_{V}={X_{V25},M_{V}}, an output end of the first layer outputs the feature map X_{GV1}, an input end of a second layer receives a graph structure G_{V1}={X_{GV1},M_{V}}, an output end of the second layer outputs the feature map X_{GV2}, an input end of a third layer receives a graph structure G_{V2}={X_{GV2},M_{V}}, an output end of the third layer outputs the feature map X_{GV3}, an input end of a fourth layer receives a graph structure G_{V3}={X_{GV3},M_{V}}, and an output end of the fourth layer outputs the feature map X_{GV4};
wherein a size of the feature map X_{GV1} is N×512;
a size of the feature map X_{GV2} is N×128;
a size of the feature map X_{GV3} is N×32;
and a size of the feature map X_{GV4} is N×1.
